(19) United States
(12) Patent Application Publication
(10) Pub. No.: US 2026/0266094 A1
(43) Pub. Date: Sep. 10, 2026

(54) ATTACHABLE SENSOR ASSEMBLY FOR A LOCK BODY

(71) Applicant: Securitech Group, Inc., Berlin, CT (US)

(72) Inventor: Nicholas Johnson, Flushing, NY (US)

(73) Assignee: Securitech Group, Inc., Berlin, CT (US)

(21) Appl. No.: 19/535,896

(22) Filed: Feb. 10, 2026

Related U.S. Application Data
(60) Provisional application No. 63/767,688, filed on Mar. 6, 2025.

(51) Int. Cl. E05B 47/00; E05B 47/02

(52) U.S. Cl. CPC E05B 47/0012; E05B 47/00; E05B 47/026

(57) ABSTRACT

A sensor assembly for a lock body of a door lock system includes a flexible printed circuit board configured to be attached to at least one exterior surface of a housing of the lock body and one or more sensors coupled to the printed circuit board. The one or more sensors are configured to sense one or more physical states of the lock body and/or door lock system.

### CROSS REFERENCE TO RELATED APPLICATIONS

This Application claims the benefit under 35 U.S.C. § 119(e) to U.S. Provisional Application No. 63/767,688, filed on Mar. 6, 2025, the disclosure of which is incorporated by reference herein in its entirety.

### FIELD

Disclosed embodiments are related to sensor assembly configured to be attachable to a lock body of a door lock system to sense one or more physical states of the lock body and/or door lock system.

### BACKGROUND

Door lock systems that include lock bodies with deadbolts and latches are well known. Mortise door lock systems, which require a mortise to be cut into a door to insert the lock body are also well known. It is common for a user to want to easily determine the status of various components of a door lock system, such as a position of the deadbolt or whether the door is open or closed.

### SUMMARY

According to some embodiments, a sensor assembly for a lock body of a door lock system is provided. Such a sensor assembly comprises a flexible printed circuit board configured to be attached to at least one exterior surface of a housing of the lock body and one or more sensors coupled to the printed circuit board, wherein the one or more sensors are configured to sense one or more physical states of the lock body and/or door lock system.

According to some embodiments, a flexible printed circuit board is provided. The flexible printed circuit board comprises a rear surface, a plurality of component receiving portions, an adhesive, and metal traces extending between the component receiving portions. The rear surface is configured to be attached to at least two exterior surfaces of a housing of a lock body. The plurality of component receiving portions are configured to receive one or more electrical components. The metal traces are configured to connect the one or more electrical components.

According to some embodiments, a door lock system is provided. The lock body comprises a housing and a printed circuit board attached to an exterior surface of the housing. The printed circuit board comprises one or more sensors configured to sense one or more physical states of the lock body and/or door lock system.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 shows a right side perspective view of a door lock system according to an illustrative embodiment;

FIG. 2 shows a right side perspective view of a sensor assembly coupled to a lock body of a door lock system according to an embodiment;

FIG. 3 shows a left side perspective view of a sensor assembly coupled to a lock body of a door lock system according to an embodiment;

FIG. 4 shows a front perspective view of a sensor assembly according to an embodiment;

FIG. 5A shows a schematic diagram of a door lock deadbolt in an open configuration according to an embodiment;

FIG. 5B shows a schematic diagram of a door lock deadbolt in a closed configuration according to an embodiment;

FIG. 6 shows a top view of a sensor assembly in an unfolded configuration according to an embodiment.

### DETAILED DESCRIPTION

Door lock systems are commonly known mechanisms used to secure a door to prevent unauthorized access, while allowing entry for certain users. Door lock systems may include a lock body that houses key components of the door lock system e.g., a latch, a deadbolt, a key spindle, etc. A door lock system may also include a user interface such as a lever trim assembly with a handle to operate the components within the lock body.

The inventors have recognized that it is often desirable to detect one or more physical states of a lock body and/or door lock system. This may allow a user to be able to determine if the door is closed and/or locked when they are not physically present by the door. Such knowledge may be important for ensuring the security of a building. To achieve this, a door lock may include one or more sensors to detect the physical states of the lock body and/or door lock system.

Current door lock sensor assemblies often require the sensor assemblies to be manufactured with and integrated into the door lock body itself, or within other door lock system components, such as lever trim assemblies. Such conventional sensor assemblies are not adaptable to different lock bodies. Lock bodies are often small and have limited space in their interior, so incorporating sensors inside the lock body may be difficult. Current “smart locks,” which are typically motorized and have integral sensing assemblies in the lock body and/or lever trim assemblies, are often expensive and require a homeowner to replace the entire door lock system. If the owner previously used a mortise lock body, this may create problems as the new lock body of the new door lock system may not fit in the pocket in the door.

Thus, the inventors have recognized the benefits of a sensor assembly configured to be attached to the exterior of a lock body to detect the various physical states of a lock body and/or door lock system. Such a system may be beneficial because it does not require the lock body to increase in size to accommodate sensors on the interior. The inventors have also recognized that a sensor assembly configured to be attached to the exterior of a lock body may be retrofit. Such a configuration may allow users to add a sensor assembly to a pre-existing lock body, thus converting the lock body into a “smart lock,” without requiring the purchase and installation of a new door lock system.

In some embodiments, a sensor assembly for a lock body of a door lock system includes a flexible printed circuit board (PCB) configured to be attached to at least one exterior surface of a housing of a lock body. The PCB may include one or more sensors configured to sense the one or more physical states of the lock body and/or door lock system. A flexible PCB may allow the sensors to be more easily aligned with parts of the lock body. In some embodiments, a flexible PCB may allow the sensor assembly to be more easily packaged and shipped. In some embodiments the sensor assembly may be adaptable to various shaped and sized lock bodies and may be substantially simple to install. In some embodiments, the sensor assembly may be designed and manufactured for a specific lock body. In some embodiments, the sensor assembly may be configured to be attached to a mortise lock body. It should be understood that in some embodiments, the sensor assembly may be attached to the lock bodies of other types of door lock systems such as a deadbolt lock, knob lock, rim lock, keypad lock, etc.

The sensor assembly may be configured to attach to any conventional lock body. For instance, in some embodiments, the lock body may include a key cylinder slot configured to receive a key cylinder. In some embodiments, the lock body may include a latch spindle slot configured to receive a latch spindle. The latch spindle may be operatively coupled to a handle, such that rotating the handle about a first lock axis rotates the latch spindle. When the latch spindle is received in the latch spindle slot, the latch spindle engages with a latch slot linkage which operatively couples the latch spindle to latch, such that rotating the handle about the first lock axis retracts or extends the latch. Examples of a suitable lock body which such a sensor assembly may be used for is disclosed in U.S. Provisional Application No. 63/734,266, the entirety of which is incorporated by reference herein.

The lock body may also include a deadbolt spindle slot which is operatively coupled to a deadbolt via a deadbolt slot linkage.

When the lock body is used with conventional lever trim assemblies, the deadbolt slot linkage generally receives a deadbolt spindle, which is operatively coupled to a thumb-turn on the interior/secured conventional lever trim assembly. In this manner, a user on the interior side of the door may rotate the thumb-turn to retract the deadbolt and rotate the handle to retract the latch. Additionally, the key cylinder slot would conventionally receive a key cylinder on the exterior/unsecured conventional lever trim assembly which would engage with the key cylinder slot linkage, allowing a user on the exterior/unsecured side of the door to retract the deadbolt and/or the latch and open the door. In some situations, the interior/secured conventional lever trim assembly may also include a key cylinder which is inserted into the key cylinder slot and coupled to the key cylinder slot linkage. Of course, it should be understood that the sensor assembly may be adapted to attach to any conventional lock body of any conventional door lock system, as the disclosure is not so limited.

In some embodiments, the sensor assembly may include a PCB having an adhesive on a rear surface of the PCB. The rear surface may be configured to be attached to at least one exterior surface of a housing of a lock body. In some embodiments, the PCB may be a flexible PCB. Such a configuration may allow the PCB to conform to the shape and size of a lock body. In some embodiments, the PCB may be configured to conform to the shape and size of multiple different versions of lock bodies. In some embodiments, a lock body may be shaped as a rectangular prism having 3 pairs of substantially parallel walls and an interior where functional components (e.g. latches, deadbolts, linkages, etc.) are located. In some embodiments, the PCB may be configured to wrap around at least one side of a lock body and a top of the lock body. In some embodiments, the PCB may be configured to wrap around at least two sides of a lock body and a top of the lock body. In some embodiments, the PCB may be configured to wrap around at least two sides of a lock body, a top of the lock body, and a front of the lock body. In some embodiments, the PCB may include one or more relief cutouts configured to allow for multiple degrees of flexibility in the PCB. Such relief cutouts may enable the PCB to bend more freely around the corners and curves of a lock body. In addition, in some embodiments, relief cutouts may allow the PCB to bend laterally in the plane of the exterior surface of the housing of the lock body that the PCB is attached to. This may be desirable for specific placement of the sensors on the lock body surface. It should be understood that the PCB may include other features to increase the flexibility of the PCB. In some embodiments, the PCB may include additional cutouts to accommodate for features on the exterior surface of the housing of the lock body such a screws, openings, spindles, buttons, or other physical features as this disclosure is not so limited.

The PCB may be made of a variety of materials, depending on its intended use, required durability, and desired electrical properties. In some embodiments, the PCB may be made of fiberglass epoxy resin, composite epoxy material, polyimide, teflon, aluminum, ceramic, and/or polyester.

In some embodiments, the PCB may be attached to an exterior surface of a housing of a lock body via a different type of fastener such as screws, nails, etc. It should be understood that in some embodiments, the PCB may be permanently attached to a lock body once attached. In such an embodiment, the PCB may still be configured to fit a variety of lock bodies but may not be removable once attached. In some other embodiments, the PCB may be removable, such that a user can remove the PCB from the lock body. This may be desirable, for instance, to allow for changing out the sensors, replacing the lock body, or adjusting the position of the PCB on the lock body.

In some embodiments, the sensor assembly may comprise one or more sensors coupled to the PCB. In some embodiments, the one or more sensors may be removably attached to the PCB. The one or more sensors may be attached to the PCB via an adhesive in some embodiments. The one or more sensors may rather be attached to the PCB via a different fastener, such as solder, screws, hook and loop fasteners, or any other fastener to secure the one or more sensors to the PCB. Removability of the one or more sensors may allow a user to replace the sensors. This may be desirable if a sensor is no longer functioning or if a user wishes to replace the sensor with a different type of sensor. A sensor assembly may also be provided to a user with the sensors not attached to the PCB. This may allow a user to pick and choose which sensors they would like to attach to the PCB. In some embodiments, the PCB may include one or more component receiving portions configured to receive one or more electrical components. The one or more electrical components may comprise the one or more sensors. In some embodiments the PCB may not include specific component receiving portions and the one or more sensors may be attached anywhere on the PCB. The PCB may include metal traces extending between the component receiving portions and configured to connect the one or more electrical components. It should be understood that in some embodiments, the one or more components may rather be connected via wires, or another form of electrical connection, as the disclosure is not so limited.

The one or more sensors may include any type of sensor configured to sense a physical state of a lock body and/or door lock system including, but not limited to, optical beam sensors, magnetic sensors, gyroscopes, accelerometers, thermocouples, moisture sensors, and/or IR optical sensors, switches. In some embodiments, the one or more sensors may include one or more optical beam sensors configured to detect movement of parts inside the lock body. In some embodiments, the lock body may comprise a door latch configured to move between a locked state and an unlocked state. The sensor assembly may include one or more optical beam sensors comprising an emitter and a receiver being arranged such that that line of sight between the emitter and receiver is blocked when the door latch is in one of the locked state or the unlocked state, and wherein line of sight between the emitter and receiver is unblocked when the door latch is in the other of the locked state or the unlocked state. In some embodiments an emitter may be placed on a portion of the PCB attached to a first side of the lock body and the receiver may be placed on a portion of the PCB attached to a second side of the lock body, opposite the first side. In such an embodiment, the emitter may emit a signal that passes through the lock body and is received by the receiver. In some embodiments, the lock body may include a first hole aligned with the emitter on the first side of the lock body and a second hole aligned with the receiver on the second side of the lock body to permit the signal emitted from the emitter to pass through the lock body and be received by the receiver. In some embodiments, when the latch is in the locked state, the signal passing through the lock body (also referred to as the line of sight) is unblocked by the latch or any other component inside the lock body. In this embodiment, as the latch is brought to the unlocked state (via motor, manual control, etc.) a part of the latch may block the signal from being received by the receiver. In another embodiment, the latch may block the line of sight in the locked state and not block the line of sight in the unlocked state. In some embodiments, the one or more optical beam sensors may be configured to detect the position of a deadbolt of a lock body in addition to or instead of a latch.

In some embodiments, the one or more sensors may include one or more magnetic sensors. In some embodiments, the one or more magnetic sensors may be disposed on a portion of the PCB that is attached to a front of the lock body. The one or more magnetic sensors may be configured to detect a proximity of the lock body to an external magnetic component. For example, a magnet may be placed on an edge of a door frame such that when the door (with the lock body) is closed, the magnet comes in close proximity to the one or more magnetic sensors. Thus, the one or more magnetic sensors may be configured to determine if the door is in an opened or closed state. In some embodiments, the one or more magnetic sensors may be configured to detect the physical state of a door part of the lock body and/or door lock system such as the location of the latch and/or deadbolt. The one or more sensors may be configured to detect other physical states of the lock body and/or door lock system, as this disclosure is not so limited.

In some embodiments, the sensor assembly may further include a controller configured to read the one or more sensors. The controller may be directly attached to the PCB, or it may be located external to the PCB. In some embodiments, the one or more sensors may communicate with the controller via metal traces or wires. In another embodiment, the one or more sensors may communicate with the controller wirelessly, such as via Bluetooth.

In some embodiments, the controller may be configured to send a signal to one or more status indicators to provide information to a user about the one or more physical states of the lock body and/or door lock system. In some embodiments, the one or more status indicators may be located within the door/door lock system. For example, the one or more status indicators may comprise LED's, speakers, vibration mechanism, and/or any other form of status indicators on the door/door lock system to indicate to a user one or more physical states of the lock body and/or door lock system. In some embodiments, the one or more status indicators may be located external to the door/door lock system. For example, the controller may send a signal to a computer at a security station of a building. The one or more status indicators may also be an alarm or other warning indicator that the door lock system is unlocked and/or open. In some embodiments, the one or more status indicators may be located within a house of a user. In some embodiments, the controller may communicate with a cellular device of a user such that an application on the cellular device can indicate to the user the status of the door/door lock system.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

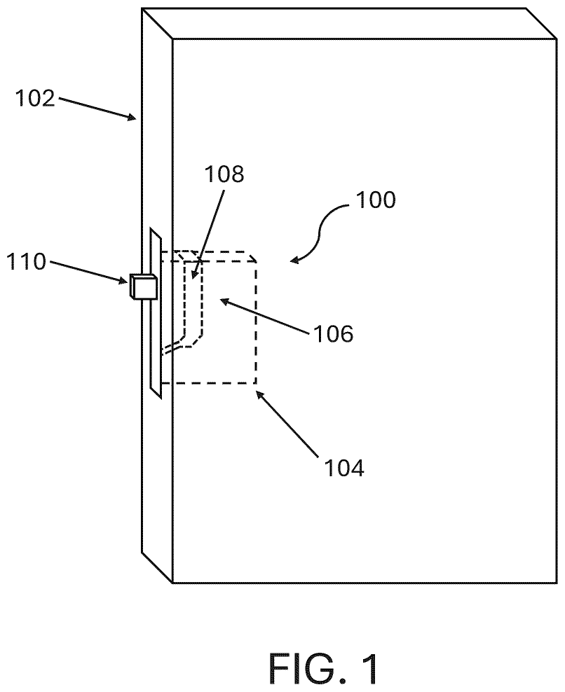

FIG. 1 shows a perspective view of a door lock system 100 for a door 102. In some embodiments, the door lock system 100 may be a mortise door lock system, such that a lock body 104 of the door lock system 100 is located within a pocket of a door 102. However, it is contemplated that in some embodiments, the lock body 104 may be configured to attach to an exterior surface of the door 102, as the disclosure is not so limited. The door lock system 100 may include one or more door lock portions (not shown) configured to mount to exterior sides of the door 102 and operatively coupled to the lock body 104 to allow users to operate the lock body 102. Such door lock portions may be, for example, lever trim assemblies, keypad, push bar or any other suitable door lock portions which allow users to operate door lock system 100. The door lock system 100 may include a sensor assembly 106 for a lock body 104 of the door lock system including a printed circuit board (PCB) 108 configured to be attached to at least one exterior surface of a housing of the lock body 104. In some embodiments the PCB 108 may be a flexible PCB 108 such that it can be folded over a lock body 104 and be arranged in a variety of configurations. In some embodiments, the sensor assembly 106 may be configured to be attached to a mortise lock body 104. It should be understood that in some embodiments, the sensor assembly 106 may be attached to lock bodies 104 of other door lock systems 100 such as a deadbolt lock, knob lock, rim lock, keypad lock, etc. It should be understood that the sensor assembly 106 may be adapted to attach to any conventional lock body of any conventional door lock system, as the disclosure is not so limited.

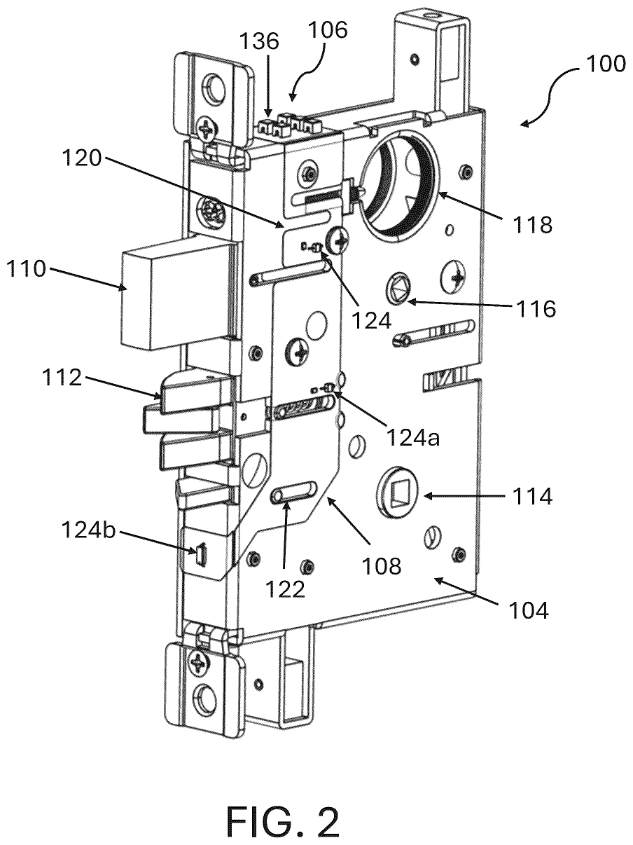

The door lock system 100 may further include at least one deadbolt 110 and/or at least one latch 112 (see FIG. 2) incorporated into to the lock body 104.

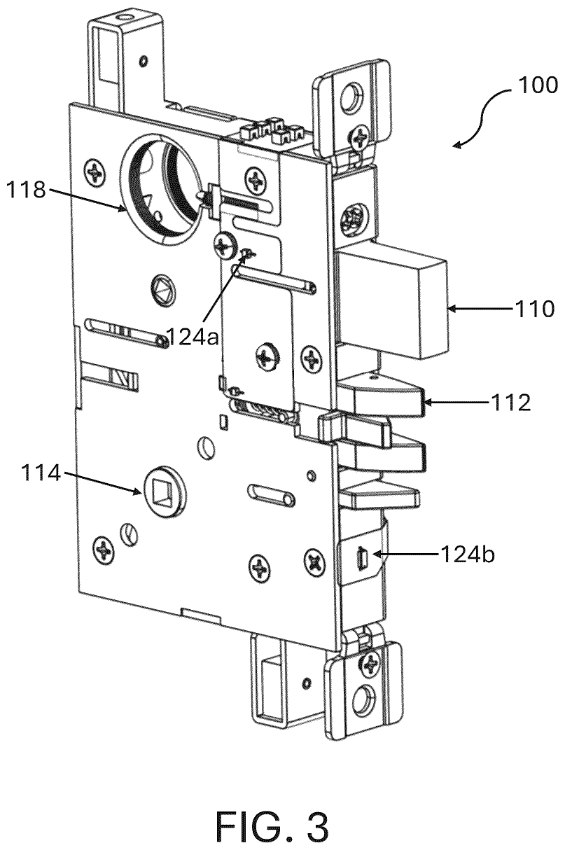

FIGS. 2 and 3 show perspective views of a lock body 104 of a door lock system 100 according to an embodiment. As seen in FIG. 2 the door lock system 100 includes lock body 104, PCB and sensor assembly 106. In some embodiments, the lock body 104 may be configured to receive a key cylinder slot. The lock body 104 may include a latch spindle slot 114 configured to receive a latch spindle (not shown). The latch spindle may be operatively coupled to a handle (not shown), such that rotating the handle about a first lock axis rotates the latch spindle. When the latch spindle is received in the latch spindle slot 114, the latch spindle engages with a latch slot linkage (not shown) which operatively couples the latch spindle to latch 112, such that rotating the handle about the first lock axis retracts or extends the latch 112.

The lock body 104 may also include a deadbolt spindle slot 116 which is operatively coupled to a deadbolt 110 via a deadbolt slot linkage (not shown). The lock body 104 may also include a key cylinder slot 118 which is operatively coupled to both the latch and the deadbolt via a key cylinder slot.

When lock body 104 is used with conventional lever trim assemblies, the deadbolt slot linkage generally receives a deadbolt spindle, which is operatively coupled to a thumb-turn on the interior/secured conventional lever trim assembly. In this manner, a user on the interior side of the door may rotate the thumb-turn to retract the deadbolt 110 and rotate the handle to retract the latch 112. Additionally, the key cylinder slot 118 would conventionally receive a key cylinder on the exterior/unsecured conventional lever trim assembly which would engage with the key cylinder slot linkage, allowing a user on the exterior/unsecured side of the door to retract the deadbolt 110 and/or the latch 112 and open the door. In some situations, the interior/secured conventional lever trim assembly may also include a key cylinder which is inserted into the key cylinder slot 118 and coupled to the key cylinder slot linkage. It should be understood that the sensor assembly 106 may be adapted to attach to any conventional lock body of any conventional door lock system, as the disclosure is not so limited.

In some embodiments, the sensor assembly 106 may include a PCB 108 having an adhesive (not shown) on a rear surface of the PCB 108. The rear surface may be configured to be attached to at least one exterior surface of a housing of a lock body 104. In some embodiments, the PCB 108 may be a flexible PCB 108. This may allow the PCB 108 to be more easily manufactured, packaged, and shipped without causing damage to the PCB 108. A user may receive the flexible PCB 108 in an unfolded configuration and attach the PCB 108 to the lock body 104 how they please. In some embodiments, the PCB 108 may be delivered with a sticker covering an adhesive on the rear surface of the PCB 108. A user may remove the sticker to be able to attach the PCB 108 to the lock body 104. In some embodiments, a PCB 108 may be able to conform to the shape and size of various lock bodies 104.

In some embodiments, a lock body 104 may be shaped as a rectangular prism having 3 pairs of parallel walls and a hollow interior where functional components are located. In some embodiments, the PCB 108 may be configured to wrap around at least one side of the lock body 104 and a top of the lock body 104. In some embodiments, the PCB 108 may be configured to wrap around at least two sides of the lock body 104 and a top of the lock body 104. In some embodiments, the PCB 108 may be configured to wrap around at least two sides of the lock body 104, a top of the lock body 104, and a front of the lock body 104. In some embodiments, the PCB 108 may include relief cutouts 120 configured to allow for multiple degrees of flexibility in the PCB 108. Relief cutouts 120 may enable the PCB 108 to bend more freely around the corners and/or curves of the lock body 104. The relief cutouts 120 may increase the flexibility of the PCB 108 to allow for a user to more easily align the PCB 108 on the exterior of the lock body 104 such that the sensors are in the correct position. In some embodiments, relief cutouts 120 may allow the PCB 108 to bend horizontally in the plane of the exterior surface of the housing of the lock body 104 that the PCB 108 is attached to. It should be understood that the PCB 108 may include other features to increase the flexibility of the PCB 108. In some embodiments, the PCB 108 may include additional cutouts 122 to accommodate for features on the exterior surface of the housing of the lock body such a screws, openings, spindles, buttons, or other physical features as this disclosure is not so limited.

In some embodiments, the PCB 108 may be made of fiberglass epoxy resin, composite epoxy material, polyimide, teflon, aluminum, ceramic, and/or polyester.

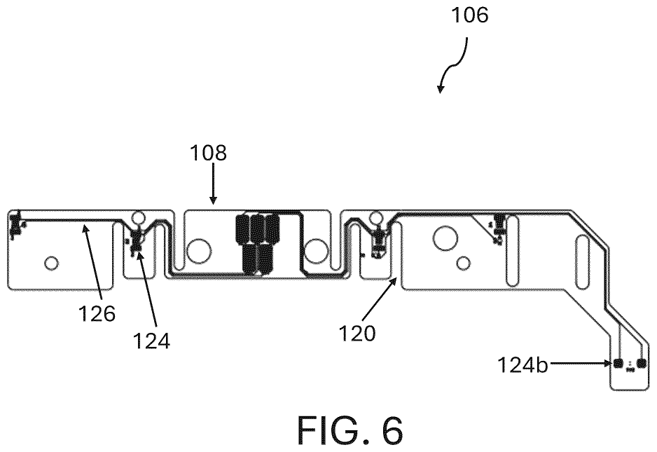

In some embodiments, the sensor assembly may comprise one or more sensors 124 coupled to the PCB 108. The one or more sensors may be configured to sense one or more physical states of the lock body and/or door lock system. In some embodiments, the one or more sensors 124 may be removably attached to the PCB 108. The one or more sensors 124 may be attached to the PCB 108 via an adhesive in some embodiments. The one or more sensors 124 may rather be attached to the PCB via a different fastener, such as screws, hook and loop fasteners, via soldering, or any other fastener to secure the one or more sensors 124 to the PCB 108. Removability of the one or more sensors 124 may allow a user to replace the sensor 124. This may be desirable if a sensor 124 is no longer functioning or if a user wishes to replace the sensor 124 with a different type of sensor 124. In some embodiments, the PCB 108 may include one or more component receiving portions configured to receive one or more electrical components 124. The one or more electrical components 124 may comprise the one or more sensors 124. In some embodiments the PCB 108 may not include specific component receiving portions and the one or more sensors 124 may be attached anywhere on the PCB 108. The PCB 108 may include metal traces 126 (see FIG. 6) extending between the component receiving portions and configured to connect the one or more electrical components 124. However, it is contemplated that in some embodiments, the one or more electrical components 124 may instead be connected via wires, or another form of electrical connection, as the disclosure is not so limited.

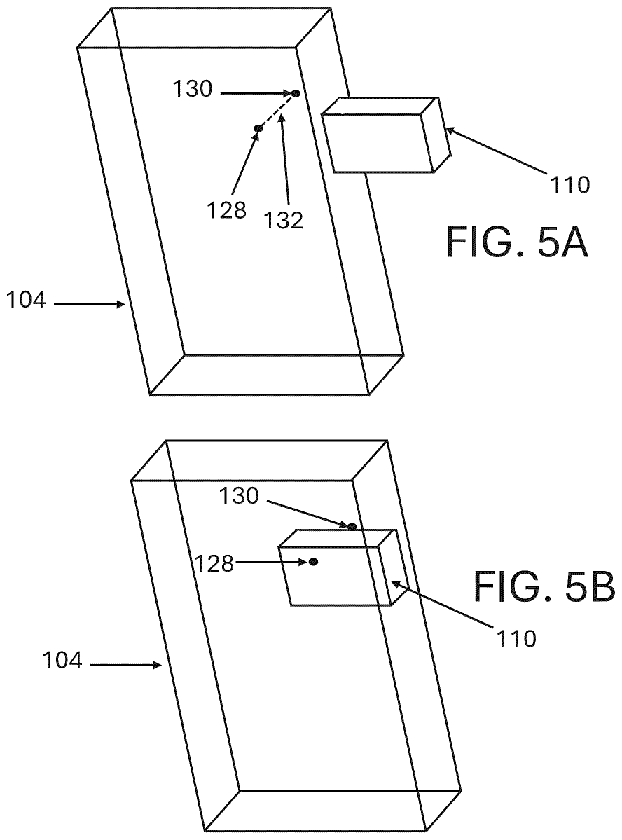

The one or more sensors 124 may include any type of sensor 124 to sense a physical state of the lock body 104 and/or door lock system 100 including, but not limited to, optical beam sensors, magnetic sensors, gyroscopes, accelerometers, thermocouples, moisture sensors, and/or IR optical sensors, switches. In some embodiments, the one or more sensors 124 may be configured to detect movement of parts inside the lock body 104. In some embodiments, the one or more sensors may include one or more optical beam sensors 124a. In some embodiments, the lock body 104 may comprise a door latch 112 configured to move between a locked state and an unlocked state. The sensor assembly may include one or more optical beam sensors 124a comprising an emitter 128 and a receiver 130 (see FIGS. 5A and 5B) being arranged such that that line of sight 132 between the emitter 128 and receiver 130 is blocked when the door latch 112 is in one of the locked state or the unlocked state, and wherein line of sight 132 between the emitter 128 and receiver 130 is unblocked when the door latch 112 is in the other of the locked state or the unlocked state, as will be discussed further herein.

In some embodiments, the one or more sensors 124 may include one or more magnetic sensors 124b. In some embodiments, the one or more magnetic sensors 124b may be disposed on a portion of the PCB 108 that is attached to a front of the lock body 104. The one or more magnetic sensors 124b may be configured to detect a proximity of the lock body 104 to an external magnet. For example, a magnet may be placed on an edge of a door frame such that when the door 102 (with the lock body 104) is closed, the magnet comes in close proximity to the one or more magnetic sensors 124b. Thus, the one or more magnetic sensors 124b may be configured to determine if the door 102 is in an opened or closed state. In some embodiments, the one or more magnetic sensors 124b may be configured to detect the physical state of a door part of the lock body 104 and/or door lock system 100 such as the location of the latch 112 and/or deadbolt 110. The one or more sensors 124 may be configured to detect other physical states of the lock body 104 and/or door lock system 100, as this disclosure is not so limited.

In some embodiments, the sensor assembly 106 may further include a controller (not shown) configured to read the one or more sensors 124. The controller may be directly attached to the PCB 108, or it may be located external to the PCB 108. In some embodiments, the one or more sensors 124 may communicate with the controller via metal traces 126 or wires. In some embodiments, the one or more sensors 124 may communicate with the controller wirelessly, such as via Bluetooth. In some embodiments, the PCB 108 may include one or more wire connectors 136 that are configured to receive one or more wires (not shown) to connect the PCB 108 to the controller. In some embodiments, the one or more wire connectors 136 may be configured to receive one or more wires that can be removably connected to the one or more wire connectors 136. In some embodiments, the one or more wires may be soldered to the one or more wire connectors 136. The one or more wires may transmit the signal from the one or more sensors 124 to the controller. In some embodiments, the controller may be located external to the sensor assembly, such as in a lever trim assembly. In some embodiments, the controller may be configured to control operation of one or more motors and/or actuators in the lever trim assembly to extend/retract and/or deadbolt based on signals received from the sensors.

In some embodiments, the controller may be configured to send a signal to one or more status indicators (not shown) to provide information to a user about the one or more physical states of the lock body 104 and/or door lock system 100. In some embodiments, the one or more status indicators may be located within the door 102/door lock system 100. For example, the one or more status indicators may comprise LED's, speakers, vibration mechanisms, and/or any other form of status indicators on the door 102/door lock system 100 to indicate to a user one or more physical states of the lock body 104 and/or door lock system 100. In some embodiments, the one or more status indicators may be located external to the door 102/door lock system 100. For example, the controller may send a signal to a computer at a security station of a building. The one or more status indicators may also be an alarm or other warning indicator that the door lock system 100 is unlocked and/or open. In some embodiments, the one or more status indicators may be located within a house of a user. In some embodiments, the controller may communicate with a cellular device of a user such that an application on the cellular device can indicate to the user the status of the door 102/door lock system 100.

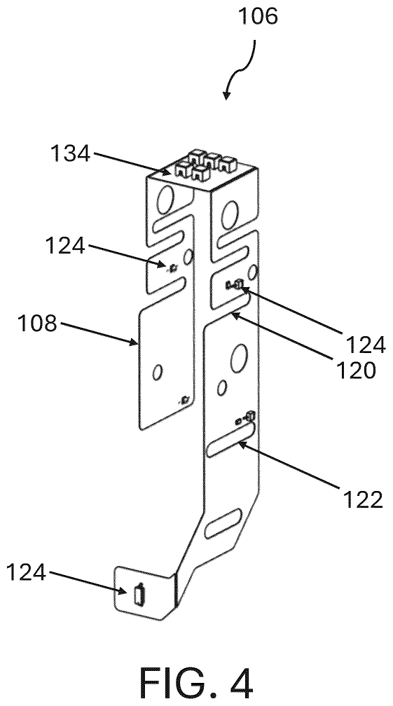

FIG. 4 shows an isolated perspective view of the sensor assembly 106. In some embodiments, a top portion 134 of the PCB 108 connects two parallel sides of the PCB 108. In some embodiments the top portion 134 may be larger or smaller than the top portion 134 shown in FIG. 4 as to accommodate for different size lock bodies 104. The sensor assembly 106 may include one flexible PCB 108 configured to wrap around the lock body 104. In some embodiments, the sensor assembly 106 may include separate PCB pieces 108 that are each configured to be attached to a corresponding side of the lock body 104. In this case, the metal traces 126 between the one or more electrical components 124 may be attached after attaching the separate PCB pieces 108 to the lock body 104.

FIGS. 5A and 5B show an illustrative embodiment of a deadbolt 110 in combination with an optical beam sensor 124a. In some embodiments an emitter 128 may be placed on a portion of the PCB 108 attached to a first side of the lock body 104 and the receiver 130 may be placed on a portion of the PCB 108 attached to a second side of the lock body 104, opposite the first side. In such an embodiment, the emitter 128 may emit a signal 132 that passes through the lock body 104 and is received by the receiver 130. In some embodiments, the lock body 104 may include a first hole (not shown) aligned with the emitter on the first side of the lock body and a second hole (not shown) aligned with the receiver on the second side of the lock body to permit the signal emitted from the emitter to pass through the lock body and be received by the receiver. As seen in FIG. 5A, in some embodiments, when the deadbolt 110 is in the locked state, the signal 132 passing through the lock body 104 (also referred to as the line of sight 132) is unblocked by the deadbolt 110 or any other component inside the lock body 104. As seen in FIG. 5B, in this embodiment, as the deadbolt 110 is brought to the unlocked state (via motor, manual control, etc.) a part of the deadbolt 110 may block the signal 132 from being received by the receiver 130. In some embodiments, when the receiver 130 does not receive the signal 132 from the emitter 128, the receiver 130 sends this information to the controller, which reads this information and interprets that the deadbolt 110 is in the unlocked state. The controller may then communicate to one or more status indicators that the deadbolt 110 is in the unlocked state. In another embodiment, the deadbolt 110 may block the line of sight 132 in the locked state and not block the line of sight 132 in the unlocked state. In some embodiments, the one or more optical beam sensors 124a may be configured to detect the position of a latch 112 of a lock body in addition to or instead of a deadbolt 110.

It should be understood that while some embodiments above disclose the line of sight being blocked with the deadbolt and/or latch, any component in the lock body 104 which moves between different positions depending on whether the leach and/or deadbolt is in the locked or unlocked state may block/unblock line of sight in order to sense the state of the latch and/or deadbolt, as the disclosure is not so limited. For instance, a portion of the latch slot linkage may selectively block and unblock the line of sight depending on the position of the latch, and/or a portion of the deadbolt slot linkage may selectively block and unblock the line of sight depending on the position of the deadbolt. It should also be understood that, in some embodiments, the sensor assembly may include multiple optical beam sensors, where one optical beam sensor is used to determine the state of a latch, and another optical beam sensor is used to determine a state of a deadbolt.

FIG. 6 shows a top view of a sensor assembly 106 laid out flat. In this embodiment, the sensor assembly 106 includes a single, flexible PCB 108 with relief cutouts 120 for additional flexibility, as previously discussed. The PCB 108 may be configured in different shapes and/or with different locations for the relief cutouts 120 and/or the one or more sensors 124. As shown in FIG. 6, in some embodiments, the metal traces 126 travel around the relief cutouts 120. In some embodiments, the metal traces 126 may travel directly over the relief cutouts 120.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A sensor assembly for a lock body of a door lock system, the sensor assembly comprising:
a flexible printed circuit board configured to be attached to at least one exterior surface of a housing of the lock body; and
one or more sensors coupled to the printed circuit board;
wherein the one or more sensors are configured to sense one or more physical states of the lock body and/or door lock system.

2. The sensor assembly of claim 1, wherein the printed circuit board is configured to wrap around at least one side of the lock body and a top of the lock body.

3. The sensor assembly of claim 1, wherein the printed circuit board is configured to wrap around at least two sides of the lock body and a top of the lock body.

4. The sensor assembly of claim 1, wherein the printed circuit board comprises relief cutouts configured to allow for multiple degrees of flexibility.

5. The sensor assembly of claim 1, wherein the printed circuit board further comprises an adhesive to attach the sensor assembly to the housing.

6. The sensor assembly of claim 1, wherein the one or more sensors are optical beam sensors, magnetic sensors, gyroscopes, accelerometers, thermocouples, moisture sensors, and/or IR optical sensors, switches.

7. The sensor assembly of claim 1, wherein the one or more sensors comprise one or more optical beam sensors configured to detect movement of parts inside the lock body.

8. The sensor assembly of claim 7, wherein the parts inside the lock body comprise a door latch configured to move between a locked state and an unlocked state, and wherein an emitter and a receiver of an optical beam sensor are arranged such that line of sight between the emitter and receiver is blocked when the door latch is in one of the locked state or the unlocked state, and wherein line of sight between the emitter and receiver is unblocked when the door latch is in the other of the locked state or the unlocked state.

9. (canceled)

10. The sensor assembly of claim 1, further comprising a controller configured to read the sensor, wherein the controller is configured to send a signal to one or more status indicators configured to provide information to a user about the one or more physical states of the lock body and/or door lock system.

11. The sensor assembly of claim 1, wherein a portion of the printed circuit board is disposed on a front side of the lock body when the printed circuit board is attached to the lock body.

12. The sensor assembly of claim 11, wherein the one or more sensors includes one or more magnetic sensors disposed on the portion of the printed circuit board attached to the front of the lock body, the one or more magnetic sensors being configured to detect a proximity of the lock body to an external magnet.

13. A flexible printed circuit board comprising:
a rear surface comprising an adhesive, the rear surface configured to be attached to at least two exterior surfaces of a housing of a lock body of a door lock system;
a plurality of component receiving portions configured to receive one or more electrical components; and
metal traces extending between the component receiving portions and configured to connect the one or more electrical components.

14. The flexible printed circuit board of claim 13, wherein the one or more electrical components comprise one or more sensors configured to detect one or more physical states of the lock body and/or door lock system.

15. The flexible printed circuit board of claim 14, wherein the one or more sensors comprise one or more optical beam sensors configured to detect movement of parts inside the lock body.

16. The flexible printed circuit board of claim 15, wherein the parts inside the lock body comprise a door latch configured to move between a locked state and an unlocked state, and wherein an emitter and a receiver of an optical beam sensor are arranged such that line of sight between the emitter and receiver is blocked when the door latch is in one of the locked state or the unlocked state, and wherein line of sight between the emitter and receiver is unblocked when the door latch is in the other of the locked state or the unlocked state.

17. (canceled)

18. The flexible printed circuit board of claim 14, wherein the printed circuit board comprises a first portion disposed on a first exterior surface of the lock body and a second portion disposed on a second exterior surface of the lock body.

19. The flexible printed circuit board of claim 13, further comprising relief cutouts configured to allow for multiple degrees of flexibility.

20. A door lock system comprising:
a lock body comprising a housing; and
a printed circuit board attached to an exterior surface of the housing, the printed circuit board comprising:
one or more sensors configured to sense one or more physical states of the lock body and/or door lock system.

21.-25. (canceled)

26. The door lock system of claim 20, wherein the one or more sensors comprise one or more optical beam sensors configured to detect movement of parts inside the lock body.

27. The door lock system of claim 26, wherein the parts inside the lock body comprise a door latch configured to move between a locked state and an unlocked state, and wherein an emitter and a receiver of an optical beam sensor are arranged such that line of sight between the emitter and receiver is blocked when the door latch is in one of the locked state or the unlocked state, and wherein line of sight between the emitter and receiver is unblocked when the door latch is in the other of the locked state or the unlocked state.

28. The door lock system of claim 20, further comprising one or more status indicators configured to provide information to a user about the one or more physical states of the lock body and/or door lock system.

29. The door lock system of claim 20, wherein the lock body is a mortise lock body.
